(19) United States
(12) Patent Application Publication
(10) Pub. No.: US 2007/0006304 A1
(43) Pub. Date: Jan. 4, 2007

(54) Optimizing malware recovery

(75) Inventors: Michael Kramer, Yonkers, NY (US); Scott A. Field, Redmond, WA (US); Marc E. Seinfeld, Hong Kong (HK)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Microsoft Corporation, Redmond, WA (US)

(21) Appl. No.: 11/172,373

(22) Filed: Jun. 30, 2005

(51) Int. Cl. G06F 12/14

(52) U.S. Cl. 726/22

(57) ABSTRACT

Malware recovery optimization is provided in which malware detection processes and protocol processes on a device are monitored for events indicating a breach of security of the device, such as the presence of an infection or other evidence of a malware attack. The devices report the events for collection on a centralized event collector that issues alerts of the events to other devices that may have been compromised as a result of the breach of security. Upon receipt of the alert, the receiving devices may initiate malware recovery optimization, including activating anti-virus software to initiate a targeted scan of those resources that may have been compromised. In this manner, malware recovery processes are optimized to recover the receiving device and/or resources when indicated.

### BACKGROUND

The speed with which malware can infect massive numbers of networked devices before being detected presents numerous challenges in defending against malware attacks. Servers that host content or other types of shared storage resources are particularly at risk of receiving infected files from attached clients. For example, a client may attach to a server and inadvertently deposit an infected file on the server's resources even if attached for only a short period of time. The server has no way to trace the client from which the infected file was received. Even if subsequently disinfected, the next time the client attaches to the server it may be re-infected if the infected file remains on the server. Other clients accessing the server could also get infected even though the client from which the infected file was received has detached. Even clients protected by anti-virus software may propagate viruses in this way if the software is not up-to-date, or if the client is infected with new viruses for which anti-virus signatures are not yet available.

One of the previously accepted approaches to this problem is to have the client's anti-virus software scan the attached file servers to disinfect them. However, this approach is not reliable, since there is no guarantee that the client has any file server shares mounted at the time that the infection is discovered. Another is to have the server's anti-virus software continuously scan all of the files on the server every time a new signature becomes available. However, given the large number of files that typically reside on a server, such indiscriminant scanning may be too resource-intensive and thus impractical, especially since signatures may be updated daily, or even several times a day.

### SUMMARY

The foregoing problems with the prior state of the art are overcome by the principles of the present invention, which is directed toward methods, systems, computer program products, and data structures for optimizing recovery from malware attacks on devices within a trust boundary.

According to one aspect of the invention, malware recovery optimization monitors malware detection processes on a device for events indicating a breach of security of the device, such as the presence of an infection or other evidence of a malware attack. The malware detection processes include but are not limited to anti-virus software and other types of malware behavior trigger engines that detect breaches of security of a device.

According to another aspect of the invention, malware recovery optimization notifies a centralized event collector when an event occurs indicating a breach of security. Notification may be performed by causing the device to report information to the centralized event collector about each event that occurs, including but not limited to, any available identification of the malware attack that caused the event to occur, the name of the device that was attacked, and the time that the attack actually or likely occurred. In some cases, the reported event information may further include the names of other devices and/or resources within the trust boundary that might also have been compromised as a result of the malware attack. For example, the reported event information may indicate the names of servers and files to which a client was attached.

According to one other aspect of the invention, malware recovery optimization may also monitor malware detection processes on a device for events indicating a breach of security during a protocol exchange between the device and another device using file sharing and other types of communication protocols, including various electronic mail and internet related protocols. During the protocol exchange, malware recovery optimization may monitor malware detection processes and protocol processes on one device as applied to communications received from another device. Monitoring the malware detection processes during a protocol exchange may be particularly advantageous when the malware detection processes on the device from which the messages are received are either non-existent or inadequate to detect the newest types of malware attacks. Similar to monitoring malware detection processes on a device for events indicating a breach of security of the device, when monitoring protocol processes malware recovery optimization notifies the centralized event collector when an event occurs indicating a breach of security during a protocol exchange.

According to one other aspect of the invention, the centralized event collector alerts some or all of the other devices within the trust boundary about each reported event in accordance With an alert configuration. The alert configuration may include rules for generating alerts that are implicitly derived from or explicitly specified by devices that have registered with the centralized event collector to receive alerts from some or all of the devices within a trust boundary. In some cases, the event collector may send alerts only to devices that have registered to receive alerts. In other cases, the event collector may send alerts only to devices that may have been compromised as a result of the malware attack, such as the servers that were attached to the client that is reporting the event. In yet other cases, the event collector may broadcast alerts to all devices within the trust boundary, such as all devices on a network. The centralized event collector may further provide an application programming interface (API) to facilitate the reporting of events to the event collector from devices, as well as to facilitate the receipt of alerts issued from the event collector to devices.

According to one other aspect of the invention, a device may receive an alert that an event was reported by another device within the trust boundary indicating a breach of security, such as the discovery of an infection or other evidence of a malware attack on the reporting device. Upon receipt of the alert, the receiving device may initiate malware recovery optimization to assess whether the breach of security on the reporting device may have also compromised the receiving device and/or resources. For example, malware recovery optimization may cause a file server to consult a server log file to determine whether the reporting client had access to files on the file server after the malware attack occurred, which could indicate that those files may have been compromised.

According to yet another aspect of the invention, after determining that the receiving device and/or resources may have been compromised, malware recovery optimization activates the receiving device's malware detection processes to begin the process of malware recovery. For example, malware recovery optimization may activate the receiving device's anti-virus software to initiate a targeted scan of those resources that may have been compromised. In this manner, malware recovery processes are optimized to recover, rollback, disinfect, or quarantine the receiving device and/or resources when indicated.

According to yet another aspect of the invention, in some cases the determination that the receiving device and/or resources on the receiving device may have been compromised can be made by the device that reports the event, and/or the centralized event collector that issues the alert. For example, in some cases a client may be able to identify in the reported event information which servers and files the client attached or accessed, and thus possibly compromised, subsequent to the malware attack. In other cases, the event collector may determine whether a registered server may have been compromised as a result of a malware attack reported by a client based on information that the server previously provided to the event collector at the time the server registered with the event collector. In this manner, the event collector may issue alerts that are properly targeted to those receiving devices that need them so that malware recovery processes are further optimized to recover, rollback, disinfect, or quarantine the receiving device and/or resources when indicated.

In accordance with yet other aspects of the present invention, a computer-accessible medium for malware recovery optimization is provided, including a medium for storing data structures and computer-executable components for malware recovery optimization functionality and a centralized security event collector. The data structures define the application programming interfaces and/or protocols to report events to the event collector and to issue alerts from the event collector in a manner that is generally consistent with the above-described systems and methods. Likewise, the computer-executable components are capable of performing malware recovery optimization functions that are generally consistent with the above-described systems and methods.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 depicts an overview of an exemplary system for optimizing recovery from a malware attack on a device within a trust boundary, formed in accordance with the present invention;

FIG. 2 depicts certain aspects of malware recovery optimization in a client/file server context in accordance with an embodiment of the present invention;

FIG. 3 depicts certain aspects of malware recovery optimization during a protocol exchange between devices in accordance with an embodiment of the present invention;

FIGS. 4A-4B are flow diagrams illustrating certain aspects of the logic performed by a general-purpose computer system for optimizing recovery from a malware attack on a device within a trust boundary, formed in accordance with an embodiment of the present invention; and

FIG. 5 is a flow diagram illustrating certain other aspects of the logic performed by a general-purpose computer system for optimizing recovery from a malware attack on a device within a trust boundary, formed in accordance with an embodiment of the present invention.

### DETAILED DESCRIPTION

The speed with which networked devices can be attacked with malware as well as the large number of files that may be exposed to such attacks in a typical file server environment suggests that it would be beneficial to optimize the malware recovery process. In the following discussion, a computing system that is suitable for implementing malware recovery optimization in accordance with embodiments of the present invention is described in detail. Optimization is achieved by initiating malware recovery of a device after determining that the device may have been compromised by a breach of security within the trust boundary, as opposed to every time the device attaches to another device, or a new anti-virus signature becomes available. Optimization is also achieved by targeting the malware recovery of a device, where the targeting narrows down the extent of the resources on the device which need to be scanned, searched, examined and remedied. Among other advantages, optimization provides devices with the ability to better respond to a malware attack so that fewer devices and files are exposed to the attack.

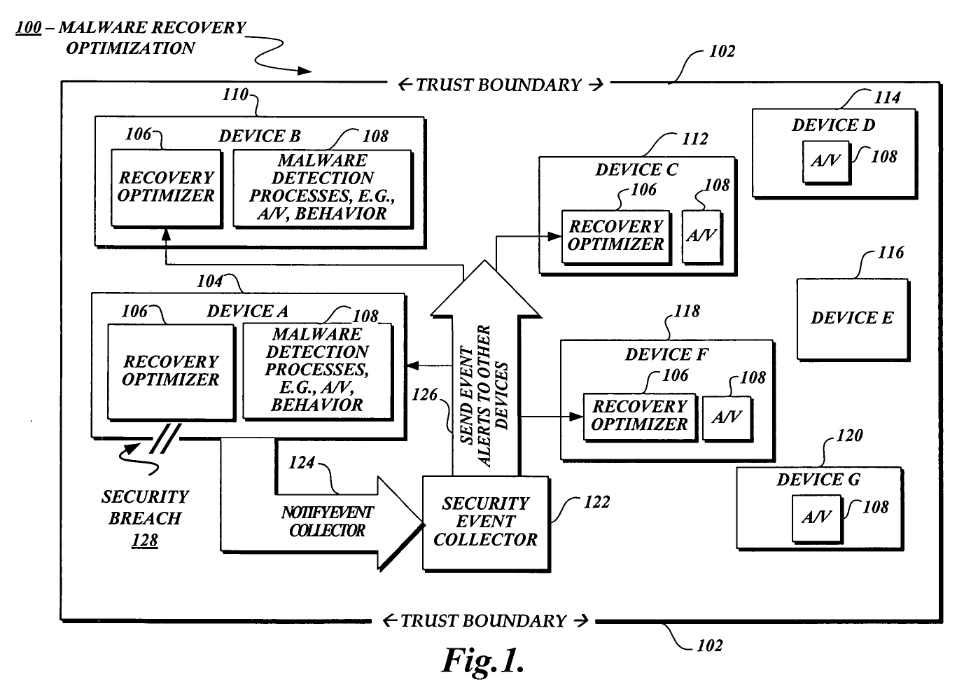

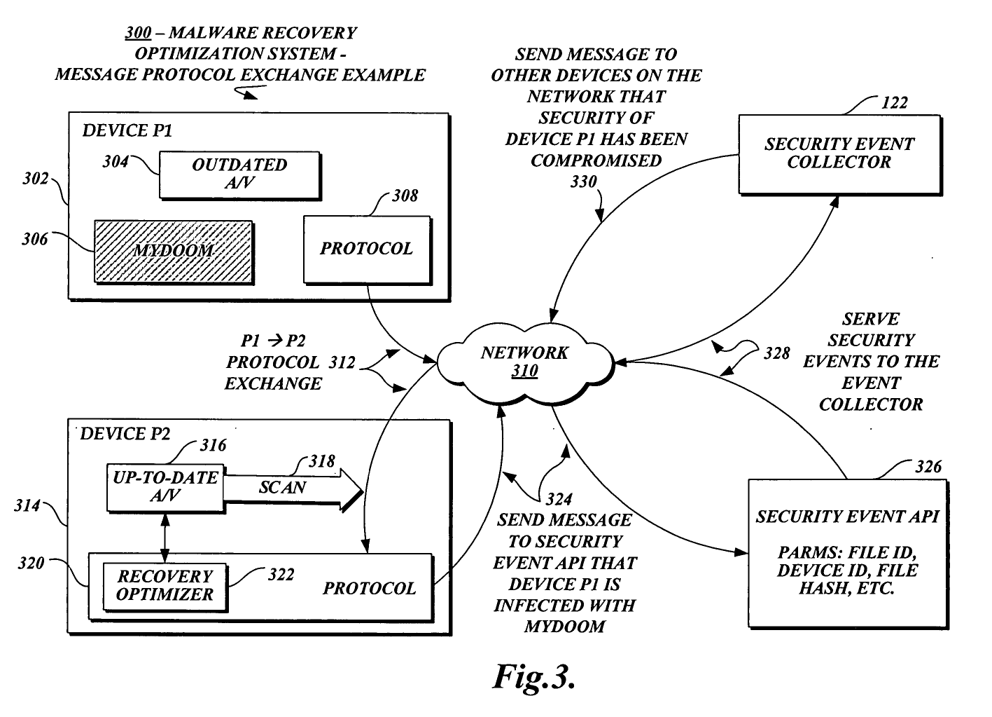

FIG. 1 depicts an overview of an exemplary system 100 for optimizing recovery from a malware attack on a device within a trust boundary 102, formed in accordance with an embodiment of the present invention. As illustrated, the system 100 includes, among other components, a recovery optimizer process 106 residing on one or more devices within the trust boundary 102, such as Device A 104, Device B 110, Device D 112, and Device F 118. The recovery optimizer process 106 operates in conjunction with malware detection processes 108 that may be installed on the devices, including but not limited to anti-virus trigger engines (A/V), behavior trigger engines, or even a manual trigger engine for detecting a breach of security of the devices. Not all of the devices may use the same types of malware detection processes 108, and in fact there may be some devices within the trust boundary 102 that have no malware detection processes 108 at all, such as Device E 116. Alternatively, or in addition, in some embodiments, the recovery optimizer process 106 operates in conjunction with protocol processes that may be installed on the devices, as will be described in further detail with reference to FIG. 3.

In one embodiment, other devices within the trust boundary 102 may operate without having the recovery optimizer process 106, such as the illustrated devices Device D 114 and Device G 120, and the aforementioned Device E 116. Devices without the recovery optimizer process 106 may co-exist with the devices that do have the recovery optimizer process 106; however, they may not be able to benefit from or participate in optimized recovery other than the fact of their co-existence with devices that do have the recovery optimizer process 106 and which are, therefore, less susceptible to attack and better able to quickly recover from an attack.

In a typical embodiment, the recovery optimizer process 106 operates in conjunction with the device on which it resides and/or any of the device's malware detection processes 108 to monitor events indicating a breach of security of the device, such as the presence of malware objects indicating an infection, or other evidence of a malware attack, including the presence of malware in memory. When such an event occurs, the recovery optimizer process 106 causes the device in which the event occurred to report the event to a security event collector 122. For example, in the illustrated embodiment, Device A 104 may discover through its malware detection processes 108 that a security breach 128 has occurred. The recovery optimizer process 106 monitors the discovery of an event indicating the security breach 128 by the malware detection processes 108 and causes Device A 104 to notify 124 the security event collector 122. The security event collector 122, in turn, issues an alert 126 about the event to some or all of the other devices, Devices B-G, 110, 112, 114, 116, 118, and 120, within the trust boundary so that they can take actions to protect themselves from a breach of security that might occur, or to recover from a breach of security that may have already occurred, as a result of the security breach 128 on Device A.

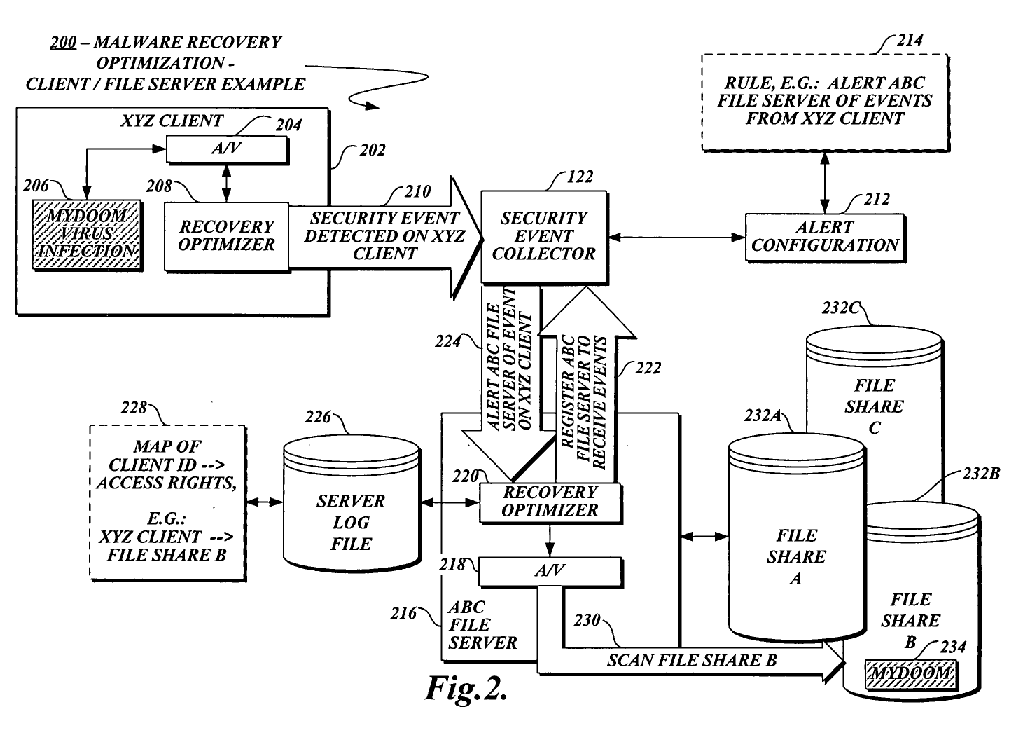

In a typical embodiment, the recovery optimizer process 106 further operates in conjunction with the device on which it resides and/or any of the device's malware detection processes 108 to receive and process alerts of events indicating a breach of security within the trust boundary 102, such as the security breach 128 on Device A. When such an alert is received from the centralized event collector 122, the recovery optimizer process 106 causes the device in which the alert was received to conduct a self assessment to determine whether the device may have been compromised as a result of the alerted event. The self-assessment may be conducted using just the event information provided in the alert, and/or in conjunction with other information that may be available to the device, such as a history of the device's interactions with the device from which the event originated. For example, in the client/file server context, a server may conduct a self-assessment upon receipt of an alert about an event on a client using a log file documenting the server's interactions with the client, as will be described in further detail with reference to FIG. 2.

In a typical embodiment, the devices A-G, 104, 110, 112, 114, 116, 118, and 120 report events and receive alerts issued by the security event collector 122 through an application programming interface (API) to the event collector, as will be described in further detail with reference to FIG. 3. The API facilitates reporting information and issuing alerts about the event from and to a variety of devices within the trust boundary, such as personal computers, client computers, file server computers and the like, and includes devices that may only be intermittently connected to devices within the trust boundary, such as laptop computers and other mobile devices. In some cases the intermittently connected devices may report and receive alerts of events that occurred while they were disconnected.

FIG. 2 depicts certain aspects of malware recovery optimization in a client/file server context in accordance with an embodiment of the present invention. As illustrated, a client/file server malware recovery optimization system 200 includes, among other components, a recovery optimizer process 208 residing on a client device, such as the XYZ client 202, and a recovery optimizer process 220 residing on a file server device, such as the ABC file server 216. In the illustrated example, the recovery optimizer process 208 monitors the device for events indicating a breach of security in conjunction with anti-virus software 204. In this case, the anti-virus software has detected such an event, namely the presence of the Mydoom Virus Infection 206. In response, the recovery optimizer process 208 causes the client 202 to report information about this event to the security event collector 122.

The ABC file server 216 has registered 222 with the security event collector 122 to receive events from the event collector 122, as evidenced in the alert configuration 212 having a rule 214 to alert the ABC file server 216 about events reported by the XYZ client 202. Accordingly, the security event collector 122 issues an alert 224 about the event on the XYZ client 202 to the ABC file server 216.

In a typical embodiment, upon receipt of the alert 224, the recovery optimizer process 220 on the ABC file server 216 conducts an assessment of whether its resources may have been compromised as a result of the event reported by the XYZ client 202. In the illustrated example, the resources that may have been compromised include three file shares maintained in the ABC file server 216, namely file share A 232A, file share B 232B, and file share C 232C. In one embodiment, the recovery optimizer process 220 on the ABC file server 216 performs the assessment by consulting a server log file 226 in which exists a map 228 of the various clients that it serves and the resources that those clients may access. From the map 228, the recovery optimizer process 220 determines that file share B 232B is a resource that may have been compromised. Accordingly, the recovery optimizer 220 operates in conjunction with the anti-virus software 218 on the ABC file server 216 to initiate a targeted scan 230 of file share B 232B. As illustrated, the scan 230 of file share B 232B will reveal that the MyDoom virus 234 is present, evidence that the file share B has, in fact, been compromised.

In a typical embodiment, the ABC file server 216 then operates in conjunction with the anti-virus software 218 to take the appropriate actions to recover, disinfect, quarantine or rollback the compromised file share B 232B and/or the ABC file server 216 so that other clients and servers are not at risk of being compromised by accessing file share B 232B. In this manner, the malware recovery optimization system 200 is able to quickly recover from the MyDoom attack, and prevent the spread of the MyDoom virus 234 to other client and server devices that may attach to the ABC file server 216.

In the above-described client/file server example, it should be understood that the recovery optimizer process 220 may employ other methods of conducting an assessment of whether a device, such as the ABC file server 216, and/or its resources have been compromised without departing from the claims that follow. For example, in some embodiments, the information that a reporting device, such as the XYZ client 202, reports about an event may include all of the information that the receiving device, such as the ABC file server 216, needs in order to make that assessment, in this case the identification of the ABC file server as a device that should be alerted, and/or the identification of file share B 232B as a resource that may have been compromised. In some embodiments, the information that the receiving device needs to make that assessment may be determined, at least in part, by the security event collector 122 that issued the alert. For example, the determination of which file server should be issued an alert may be determined by the security event collector 122 using the information provided by the devices that registered with the collector 122 to receive alerts about events from certain other devices, such as the information provided by the ABC file server 216 when it registered with the event collector 122 to receive alerts about events from the XYZ client 202 as indicated in the alert configuration 212 and rule 214.

FIG. 3 depicts certain aspects of malware recovery optimization during a protocol exchange between devices in accordance with an embodiment of the present invention. As illustrated, a malware recovery optimization system 300 using a protocol includes, among other components, devices P1 302 having protocol process 308 and P2 314 having protocol process 320 in communication with Network 310 using a protocol exchange 312. In the illustrated example, Device P1 has outdated anti-virus software 304 and is infected with the Mydoom virus 306, whereas Device P2 has up-to-date anti-virus software 316. In addition, the protocol process 320 in Device P2 314 includes a recovery optimizer process 322 that operates in conjunction with the up-to-date anti-virus software 316 to scan 318 messages from other devices such as Device P1 to check for the presence of a malware attack. Similar to the malware recovery optimization described with reference to FIGS. 1 and 2, the recovery optimizer process 322 monitors Device P2 314 for events indicating a breach of security in conjunction with anti-virus software 316, and in this case, also in conjunction with the protocol process 320. Here, the anti-virus software 316 has detected such an event, namely evidence that the presence of the Mydoom virus 306 in Device P1 has compromised a communication sent from Device P1 302 to Device P2 314 via the protocol exchange 312. In response, the recovery optimizer process 322 causes the protocol process 320 on Device P2 314 to report information about this event to a security event API 326 by sending a message 324 to the API indicating that Device P1 is infected with the Mydoom 306 virus. The message 324 may include but is not limited to various parameters, such as the file ID that Device P1 302 was attempting to send to Device P2 314 and the associated file hash, and the device ID of the device harboring the virus, here Device P1 302.

In a typical embodiment, upon receipt of the message 324, the security event API 326 reports the information about the event by serving security event messages 328 to a security event collector 122. The security event collector 122 is in communication with the Network 310, and similarly to the security event collector described with reference to FIGS. 1 and 2, will in turn send an alert message 330 to some or all of the other devices on the Network 310 that the security of Device P1 has been compromised by the MyDoom virus 306. Those other devices on the Network 310 that have their own recovery optimizer processes such as the recovery optimizer process 322 on Device P2 314, may then conduct a self-assessment to determine whether they may also have been compromised, and to operate in conjunction with their own malware detection processes, such as the anti-virus software 316 on Device P2 to take corrective action to recover, rollback, quarantine, and/or disinfect their own resources. In some cases, the recovery optimizer process 322 on Device P2 314, and any other recovery optimizer processes on the other devices in the Network 310 may further operate in conjunction with the protocol process 320 on their respective devices to prevent Device P1 302 from accessing their resources until the security of Device P1 has been restored.

In the above-described protocol example described in FIG. 3, it should be understood that the recovery optimizer process 322 and security event collector 122 may operate in the context of many different types of protocols without departing from the claims that follow. For example, in one embodiment, the protocol exchange 312 between Device P1 302 and Device P2 314 may be conducted using any of a number of protocols 308/320, including but not limited to file sharing protocols, such as the Common Internet File Sharing (CIFS) protocol or other variants of the Server Message Block (SMB) protocol, various peer-to-peer (P2P) network protocols, HTTP, FTP, and the like, mail-related protocols, such as the Simple Mail Transport Protocol (SMTP), Post Office Protocol (POP), Internet Message Access Protocol (IMAP), and the like, and miscellaneous communication protocols for other types of applications, such as instant text messaging (IM) via a Session Initiation Protocol (SIP), and voice messaging using Voice over Internet Protocol (VoIP).

Further, with reference to both FIGS. 2 and 3, it should be understood that these are but two examples of situations in which malware recovery optimization may be employed in accordance with an embodiment of the invention. For example, it may be that malware recovery optimization may be employed in a client/server context, as described in FIG. 2, in combination with employing a protocol process, as described in FIG. 3, in accordance with one embodiment of the invention.

Still further, not all of the components described in FIGS. 1-3 may be necessary in order to successfully optimize malware recovery in accordance with an embodiment of the invention. For example, an embodiment of malware recovery optimization may be employed without the use of a centralized event collector, in which case the reporting devices may convey the information about the reported events directly to the receiving devices that may have been compromised as a result of the events about which information is being reported.

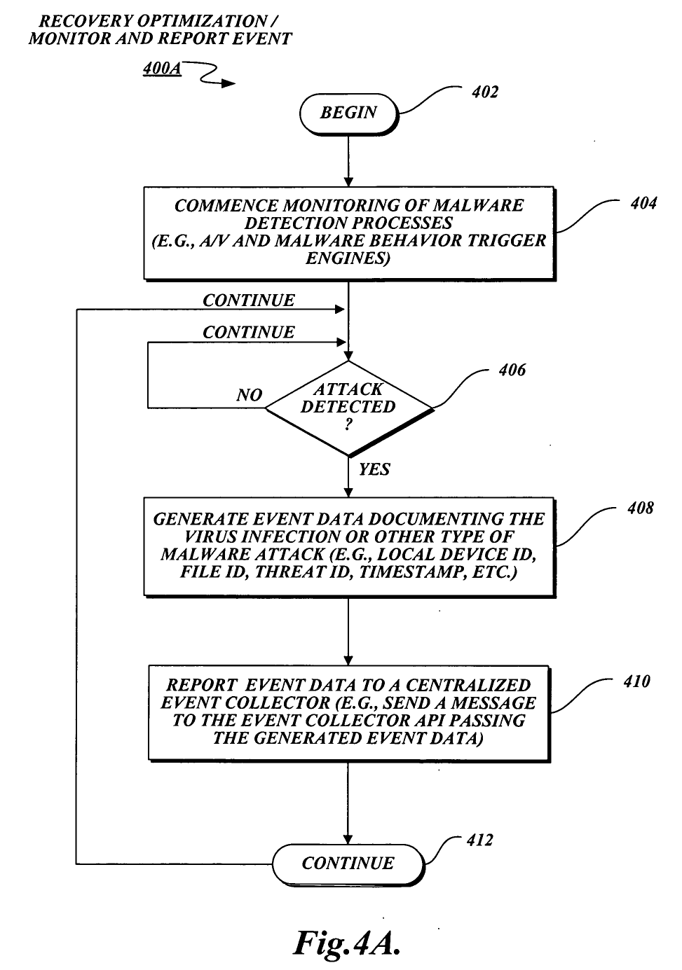

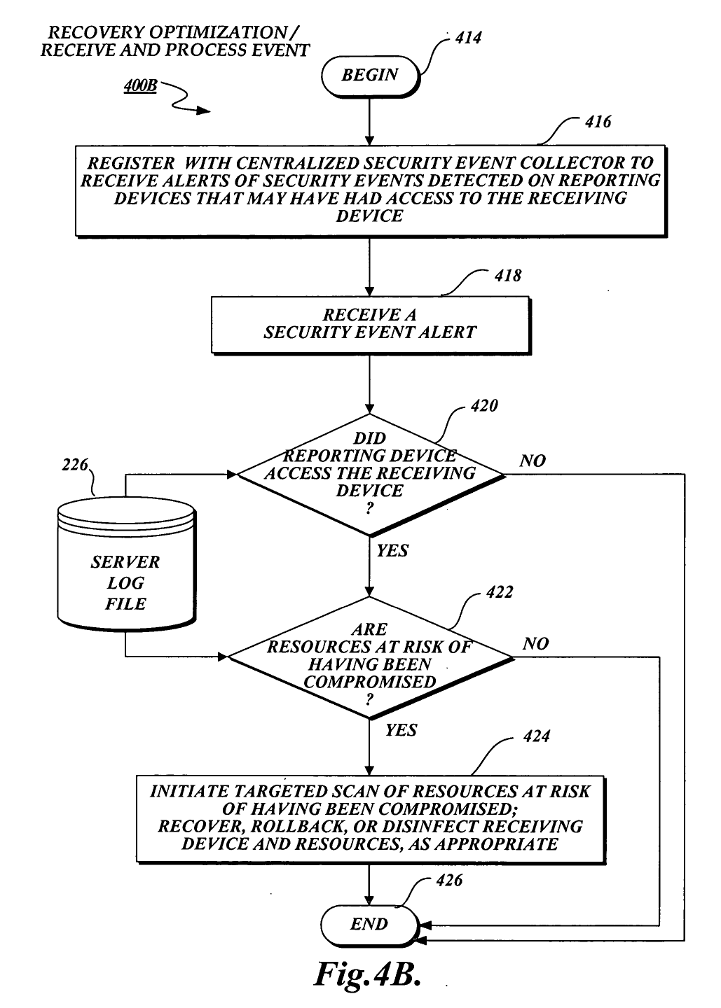

Turning now to FIG. 4A, in which is shown a flow diagram illustrating certain aspects 400A of a method performed by a general-purpose computer system for optimizing recovery from a malware attack on a device within a trust boundary, formed in accordance with an embodiment of the present invention. At starting oval 402, the method 400A begins to monitor and report events at process block 404 by commencing monitoring of local malware detection processes on a device, such as the device's anti-virus software and malware behavior trigger engines. In some cases, the monitoring of local malware detection processes may be conducted in the context of the device's protocol processes, such as described with reference to FIG. 3. The method 400A continues at decision block 406 to determine whether an attack has been detected. If not, the method 400A continues monitoring the device. If, however, an attack has been detected, then the method 400A continues at process block 408 to generate event data documenting the attack, e.g., a local virus infection or an infected message from another device, and the like. The event data that is generated may include but is not limited to, the device ID of the device under attack, the file ID involved in the attack, the threat ID of the attack, if known, the timestamp of the actual or likely time of the attack if known, and so forth.

In a typical embodiment, the method 400A continues at process block 410 to report the generated event data to a centralized event collector. In one embodiment, reporting the generated event data may be performed through an event collector API and/or in accordance with a protocol used to communicate between the devices and the event collector. After reporting the event data, the method 400A continues to monitor the device for events at processes 404 and decision block 406.

FIG. 4B, is another flow diagram illustrating certain other aspects 400B of a method performed by a general-purpose computer system for optimizing recovery from a malware attack on a device within a trust boundary, formed in accordance with an embodiment of the present invention. At starting oval 414, the method 400B begins to receive and process events at process block 416 by optionally registering a device with a centralized security event collector to receive alerts of security events detected on reporting devices that may have had access to the receiving device. For example, a server device may optionally register with an event collector to receive alerts from one or more client devices as was described in detail with reference to FIG. 2. As another example, a client device may want to register with an event collector to receive alerts from all of the servers to which it may attach, as well as all of the other clients that attach to those same servers.

In a typical embodiment, the method 400B continues at process block 418 in which a device receives an alert issued by the centralized event collector about a security event on another device within the trust boundary shared with the receiving device. Using the example described in FIG. 2, a file server device may receive an alert about a breach of security that occurred on a client device to which it was previously attached.

Upon receipt of the alert, the method 400B continues at decision block 420 to make an assessment whether the receiving device may have been compromised as a result of the reported event. In one embodiment, the method 400B makes this assessment by determining whether the reporting device, i.e., the device on which the event occurred, had access to the receiving device after the event occurred. In such cases, the receiving device may consult additional historical information, such as a server log file 226, in order to make the determination. In other cases, the receiving device may make the determination from the information reported about the event alone, without having to consult any additional information. Either way, if the receiving device determines that it may have been compromised, then the method 400B continues at decision block 422 to continue the assessment. For example, at decision block 422, the receiving device may determine whether any resources on the device may have been compromised as a result of the reported event. Again, the receiving device may consult additional historical information, such as the server log file 226, or may make the determination from the information reported about the event alone.

In a typical embodiment, should the receiving device determine that any of its resources may have been compromised as a result of the reported event, then the method 400B continues at process block 424 to initiate a targeted scan of the resources that were determined to be at risk of having been compromised. For example, the method 400B may cause anti-virus software on the receiving device to scan the at risk resources and to recover, rollback, disinfect, or quarantine the device and/or at risk resources as appropriate, and to end processing and termination oval 426.

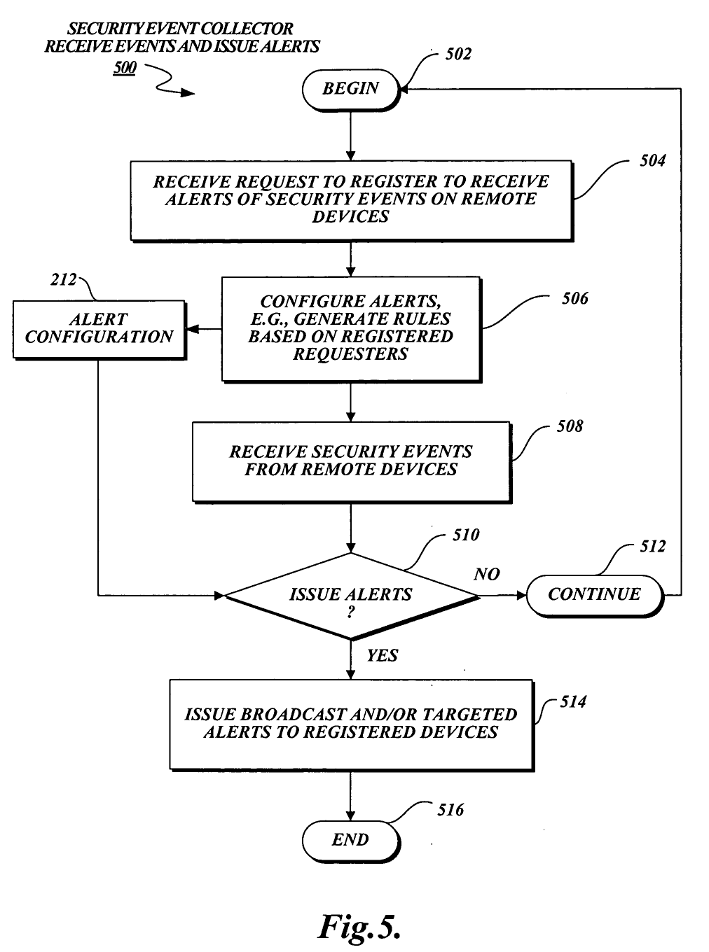

Turning now to FIG. 5, in which is shown a flow diagram illustrating certain aspects of a method 500 performed by a general-purpose computer system for optimizing recovery from a malware attack on a device within a trust boundary, formed in accordance with an embodiment of the present invention. At starting oval 502, the method 500 begins to receive events and issue alerts at process block 504 by optionally receiving requests in a centralized event collector from devices to receive alerts about events reported by other devices, where the events indicate that a breach of security occurred on the reporting device.

In a typical embodiment, at process block 506 the method 500 may optionally configure alerts by generating an alert configuration 212. The alert configuration 212 may include, among other data, rules for issuing alerts to devices about events that have been collected by the centralized event collector. In one embodiment, the rules may be derived from the registration requests received in process block 504. For instance, if a file server device has registered to receive alerts from specified client devices, then rules may be generated to insure that the event collector issues alerts to the file server device about events reported by any or all of the specified client devices, as was described in the example in FIG. 2.

In a typical embodiment, the method 500 continues at process block 508 to receive in a centralized event collector reports of security events from reporting devices. The reports that are received may include various information about an event, such as the device ID of the device in which the event occurred, the file ID of files associated with the event, the threat ID associated with the event, the time that the event likely occurred, and so forth. In one embodiment, the information may be reported via a centralized security event API and/or in accordance with a particular protocol.

In one embodiment, the method 500 continues at decision block 510 in which the centralized event collector makes a determination in conjunction with the alert configuration 212 about whether to issue an alert about an event that was reported. In no alert is issued, the method 500 continues a processing oval 512 to return to oval 502 and continue to register devices and receive events reported from devices. If an alert is to be issued, the method 500 continues at process block 514 to issue a broadcast or targeted alert about a reported event to some or all devices that may be interested in the event in accordance with the alert configuration 212. In one embodiment, those devices that may be interested in the event may include those devices that have explicitly registered to receive alerts about events reported by specified devices, as well as those devices which may have been compromised as a result of the reported event, regardless of whether the device has registered to receive such alerts. The determination about the devices to which alerts should be issued may vary from one implementation to the next, and in some cases may be dictated by the information that the reporting device reports about the event. For example, in some cases the device that reported the event may be able to identify in the information reported about the event, the other devices within the trust boundary that may have been compromised as a result of the event. The method 500 concludes processing at termination oval 516.

In the foregoing discussion, a computing system suitable for implementing various features of malware recovery optimization in accordance with embodiments of the invention includes, for example, a personal computer usable in a distributed computing environment, in which complementary tasks may be performed by remote computing devices linked together through a communication network. However, those skilled in the art will appreciate that embodiments of the invention may be practiced with many other computer system configurations. For example, embodiments of the invention may be practiced with a personal computer operating in a standalone environment, or with multiprocessor systems, minicomputers, mainframe computers, and the like. In addition, those skilled in the art will recognize that embodiments of the invention may be practiced on other kinds of computing devices including laptop computers, tablet computers, personal digital assistants (PDAs), cell phones, game consoles, personal media devices, or any device upon which computer software or other digital content is installed.

For the sake of convenience, some of the description of the computing system suitable for implementing various features of the invention may have included references to the Windows operating system, and/or references to various other Microsoft products. However, those skilled in the art will recognize that those references are only illustrative and do not serve to limit the general application of embodiments of the invention. For example, embodiments of the invention may be practiced in the context of other operating systems such as the LINUX or UNIX operating systems, and other general-purpose software.

Certain aspects of embodiments of the invention have been described in terms of programs executed or accessed by an operating system in conjunction with a personal computer. However, those skilled in the art will recognize that those aspects also may be implemented in combination with various other types of program modules or data structures. Generally, program modules and data structures include routines, subroutines, programs, subprograms, methods, interfaces, processes, procedures, functions, components, schema, etc., that perform particular tasks or implement particular abstract data types.

Lastly, while numerous embodiments of the invention have been illustrated and described, it will be appreciated that various changes can be made therein without departing from the scope of the claims that follow. For example, in one embodiment of the present invention, the functionality of the various components of a system for optimizing recovery from a malware attack may be implemented in different combinations of processes, programs, interfaces, and repositories, and may be distributed across one or more computing devices. For example, with reference to FIGS. 1-3, some of the functionality of the system, such as the recovery optimizer processes 106/322, may be implemented as part of the malware detection processes 108 and/or as part of the protocols 308/320 in use by the devices in the system, while other functions, such as the centralized event collector functions of the security event collector 122, may be distributed among one or more devices in a network. It will be further appreciated that although the embodiments of the invention have been described in the context of recovering from an infection caused by a malware attack, the methods and systems may also be applied to reverse the effects of contamination caused by the presence of unwanted software, such as performance degradation due to spyware or adware.

The embodiments of the invention in which an exclusive property or privilege is claimed are defined as follows:

1. A method for recovering a device from a breach of security, the method comprising:
receiving, in a device within a trust boundary, information about an event indicating a breach of security within the trust boundary;
determining that the receiving device may have been compromised as a result of the breach of security; and
initiating an action to recover the receiving device.

2. The method of claim 1, wherein the action to recover the receiving device includes identifying which of a plurality of resources on the receiving device may have been compromised as a result of the breach of security, and initiating an action to recover the identified resource.

3. The method of claim 2, wherein the action to recover the identified resource includes at least one of an action to scan, search, examine, remedy, disinfect, quarantine, rollback, and restore the identified resource.

4. The method of claim 1, wherein determining that the receiving device may have been compromised as a result of the breach of security includes determining that a device associated with the event had access to the receiving device.

5. The method of claim 4, wherein having access to the receiving device includes having access to a resource on the receiving device.

6. The method of claim 5, wherein the receiving device is a file server, and the resource on the receiving device is a file share hosted on the receiving device, wherein having access to the resource includes mounting the file share.

7. The method of claim 2, wherein the device associated with the event detected the breach of security within the trust boundary during an interaction with another device within the trust boundary according to a protocol.

8. The method of claim 7, wherein the protocol is any one of a file sharing protocol, a network protocol, a mail protocol, and a message protocol, the message protocol including any one of a text message protocol and a voice message protocol.

9. The method of claim 1, further comprising:
reporting to an event collector from a device associated with the event, the information about the event indicating the breach of security; and
issuing to the receiving device from the event collector an alert of the event about which information was reported.

10. The method of claim 9, wherein reporting the information includes reporting at least one of an identification of a device in which the breach of security occurred, an identification of a threat associated with the breach of security, and an identification of a file associated with the breach of security.

11. A system for optimizing recovery from a breach of security within a trust boundary, the system comprising:
an event collector to collect information reported from a first device about an event indicating a breach of security of a trust boundary,
the event collector to further issue an alert about the event to a second device within the trust boundary that may have been compromised as a result of the breach of security; and
the second device to initiate an action to recover from the breach of security.

12. The system of claim 11, further comprising:
an event application programming interface (API) to facilitate reporting information and issuing the alert about the event, the API having parameters for passing information about the event, including a file ID, a device ID, and a file hash associated with the event.

13. The system of claim 11, further comprising:
an alert configuration of the event collector, wherein the event collector issues the alert about the event to the second device within the trust boundary based on the alert configuration.

14. The system of claim 13, wherein the alert configuration is derived from information provided by the second device upon registering with the event collector to receive alerts about events, the alert configuration including a rule indicating that the second device may have been compromised as a result of events reported by the first device.

15. The system of claim 11, wherein the event indicating the breach of security of the trust boundary is a malware attack on a device within the trust boundary.

16. The system of claim 11, wherein the first device reporting the event to the event collector is a client and the second device receiving the alert about the event is a file server having a shared resource accessible to the client.

17. A computer-accessible medium having instructions for optimizing recovery from a breach of security within a trust boundary, the instructions comprising:
monitor processes on a first device within a trust boundary for an event indicating a breach of security;
convey information about the event to a second device within the trust boundary that may have been compromised as a result of the breach of security detected on the first device; and
recover the second device after determining that the second device has been compromised.

18. The computer-accessible medium of claim 17, wherein the instruction to monitor processes on a first device within a trust boundary for an event indicating a breach of security includes an instruction to monitor at least one of a malware detection process and protocol process.

19. The computer-accessible medium of claim 18, wherein the malware detection process includes at least one of an anti-virus software and a malware behavior process, and further wherein the protocol process includes at least one of a file sharing protocol, an email protocol, a voice message protocol, an instant message protocol, and a peer-to-peer network protocol process.

20. The computer-accessible medium of claim 17, wherein the instruction to convey information about the event to the second device includes an instruction to report the information about the event to an event collector, and another instruction to issue an alert about the event from the event collector to the second device in accordance with an alert configuration.
